(19) United States
(12) Patent Application Publication
(10) Pub. No.: US 2010/0195208 A1
(43) Pub. Date: Aug. 5, 2010

(54) CUSTOMISATION OF A HOT STAMP FOIL OR LAMINATE

(75) Inventors: Stephen DONE, Quorn (GB); Alan LAKE, Midlothian, VA (US)

Correspondence Address: ROTHWELL, FIGG, ERNST & MANBECK, P.C., 1425 K STREET, N.W., SUITE 800, WASHINGTON, DC, 20005, US

(73) Assignee: API GROUP PLC, Poynton (GB)

(21) Appl. No.: 12/700,270

(22) Filed: Feb. 4, 2010

(30) Foreign Application Priority Data
Feb. 5, 2009 (GB) 0901959.7

(51) Int. Cl. G02B 27/44; B05D 5/06

(52) U.S. Cl. 359/565; 427/162

(57) ABSTRACT

A method of producing a film having a diffractive surface pattern in selected areas by processing a precursor film having a diffractive surface relief throughout one or more zones together defining a target area of the precursor film; the method comprising applying material to a selected zone of the diffractive surface relief so as to nullify the diffractive effect of the surface relief in the zone.

### FIELD OF INVENTION

The present invention relates to a film and the production of a film having a diffractive surface pattern in selected areas.

### BACKGROUND

Holograms or diffractive optical structures are used, for example, on credit cards and packaging as a way of identifying that the underlying item is genuine, and/or to provide a pleasing visual effect on the surface of an item. Such holograms and other diffractive optical structures can be fabricated in to a laminate or hot stamp film that can then be applied to the surface of an item.

The visual effect present in the hologram or other diffractive optical structure is determined by the diffractive surface pattern integrated in to the structure. If a different visual effect or a customised version of the visual effect is required then a new patterned origination would need to be created. This patterned origination is used in fabrication of the diffractive surface pattern present in the hologram or other diffractive optical structure. Alternatively after the hologram has been applied to the surface of the item ink could be printed on top of the hologram to customise the appearance of the hologram.

It would therefore be desirable to have a method of customising the visual effect present in the hologram or other diffractive optical structure at the production stage.

### SUMMARY OF THE INVENTION

According to one aspect of the present invention there is provided a method of producing a film having a diffractive surface pattern in selected areas by processing a precursor film having a diffractive surface relief throughout one or more zones together defining a target area of the precursor film; the method comprising: applying material to a selected zone of the diffractive surface relief so as to nullify the diffractive effect of the surface relief in the zone.

The material may nullify the diffractive effect of the surface relief in the zone by having a refractive index similar to that of the precursor film.

The precursor film may comprise a substrate and a layer applied to the substrate, the layer having the diffractive surface relief. The material may nullify the diffractive effect of the surface relief in the zone by having a refractive index similar to that of the layer having the diffractive surface relief.

After the step of applying material the method may further comprise the step of applying a reflective coating to the surface of the diffractive surface relief and to the surface of the material applied to the diffractive surface relief. The reflective coating may be an aluminium coating. The reflective coating may have a high refractive index.

The material may be applied to the selected zone as a planarizing layer. The material may be applied to the selected zone in a quantity sufficient to level off the diffractive surface relief. The material may conform to the diffractive surface relief.

According to a second aspect of the present invention there is provided a film having a diffractive surface pattern in selected areas, the film comprising: a precursor film having a diffractive surface relief throughout one or more zones together defining a target area of the precursor film; material applied to a selected zone of the diffractive surface relief so as to nullify the diffractive effect of the surface relief in the zone.

The material may nullify the diffractive effect of the surface relief in the zone by having a refractive index similar to that of the precursor film.

The precursor film may comprise a substrate and a layer applied to the substrate, the layer having the diffractive surface relief. The material may nullify the diffractive effect of the surface relief in the zone by having a refractive index similar to that of the layer having the diffractive surface relief.

The film may further comprise: a reflective coating applied to the surface of the diffractive surface relief and to the surface of the material applied to the diffractive surface relief. The coating may be an aluminium coating. The coating may have a high refractive index.

The material may be a planarizing layer in the selected zone. The material may be of sufficient thickness in the selected zone to level off the diffractive surface relief. The material may conform to the diffractive surface relief.

### BRIEF DESCRIPTION OF THE DRAWINGS

Embodiments of the invention will now be described, by way of example only, with reference to the accompanying drawings in which:

FIG. 1 shows an example of a film having a diffractive surface relief.

FIG. 2 shows an example of a printing cylinder for the application of material to the diffractive surface relief.

FIG. 3 shows one schematic configuration of a machine used to print material on to the diffractive surface relief.

FIG. 4 shows an example of the film in FIG. 1 with material applied in selected zones.

FIG. 5 shows an example of the film in FIG. 4 with a coating applied to the back of the film.

FIG. 6 shows the illustrative result of the application of material to the path of light passing through the film.

### DETAILED DESCRIPTION OF PREFERRED EMBODIMENTS

The method described below provides a way of producing a film, such as a holographic laminate or hot stamp foil, having a diffractive surface pattern in selected areas by processing a precursor film having a diffractive surface relief such that the diffractive surface relief is nullified in selected zones. The diffractive surface relief is nullified by the application of a material in the selected zones; the material having similar optical properties to the film having a diffractive surface relief. This material can be coloured or clear depending on the visual effect required in these selected zones.

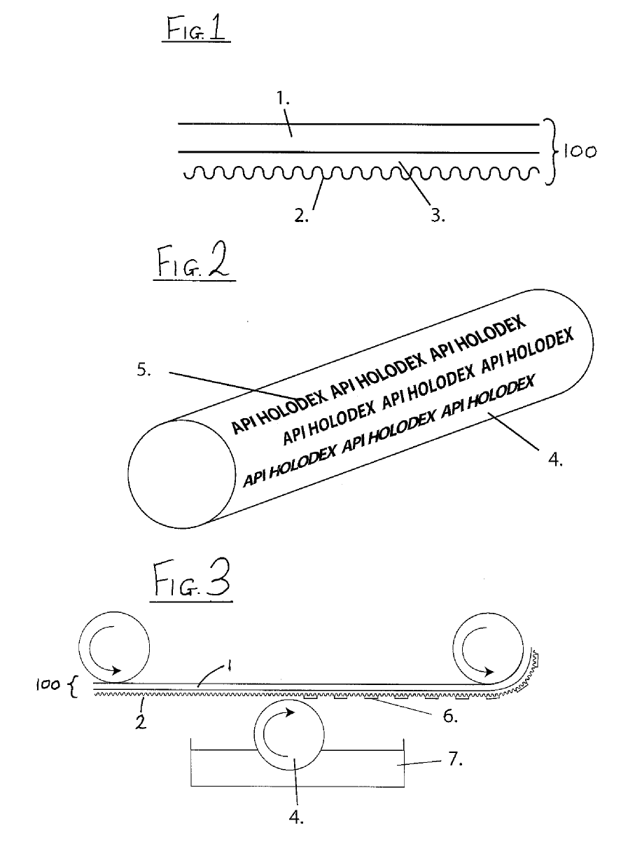

FIG. 1 shows a substrate 1 having a diffractive surface relief 2 on one side of the substrate 1. This diffractive surface relief 2 can be fabricated from a medium 3, for example by pressing the medium with an embossing shim. The medium 3 may be a lacquer, a UV cured resin coating, or alternatively the diffractive surface relief 2 could be present in the substrate 1 and so the medium 3 would be the substrate 1. The medium 3, and/or substrate 1 may contain coloured dyes or pigments to alter the visual appearance of these layers. Alternatively the medium 3 and/or substrate 1 may be substantially clear with no colourings applied at this stage. The substrate 1 may, for example, be made from materials such as PET, BOPP, or vegetable based polymer films. The medium 3 can, for example, be made from a polymeric substance such as nitrocellulose or acrylic polymer.

The precursor film 100 described above may be fabricated prior to undertaking the process detailed below. Precursor films with various diffractive surface relief structures could then be produced. When production of the customised film having a diffractive surface pattern takes place the correct precursor film 100 can be selected based on the background visual effect needed. The precursor film 100 may have the diffractive surface relief, same visual effect or hologram, over the entire surface of the film. Alternatively, different visual effects, or holograms, could be present so that after customisation the film can be sliced into separate areas.

The precursor film 100 described above can then be customised to create a new pattern or specific logo within the diffractive surface relief 2 present on or in the substrate 1. This customisation can be achieved by printing material 7 on to the diffractive surface relief 2. The material 7 can be printed on to the diffractive surface relief 2 using a printing cylinder 4, an example of which is shown in FIG. 2. Alternatively, the material 7 could be printed by other methods including, for example, selective deposition using ink jet printing. The material 7 can be in the form of an ink, lacquer or another substance having the required viscosity and/or refractive index to be applied to the diffractive surface relief 2. The material 7 could be a nitrocellulose or acrylic polymer as used for the medium 3; the material 7 could be the same substance as the medium 3. Alternatively the material 7 could be a different polymer or other material having the required refractive index properties described below.

One further method of applying the material 7 is the use of flexography. A positive mirrored master of the required image is created as a surface relief on a flat surface. The raised areas of the flexographic surface relief can then be used to apply material to the diffractive surface relief 2.

In the case that a printing cylinder 4 is used to apply the material 7 to the diffractive surface relief 2 this printing cylinder 4 needs to be fabricated prior to the step of applying material 7. The printing cylinder 4 can be made using electromechanical engraving, direct laser engraving, or chemical etching to create the small recessed cells 5 or dots that can act as tiny wells. These wells can then contain the material 7 that is to be applied to the diffractive surface relief 2.

FIG. 3 shows a schematic example configuration of a machine that uses the printing cylinder 4 to print the material 7 on to the diffractive surface relief 2 present on the precursor film 100. In this example the precursor film 100 is fabricated as a roll that can be passed across a number of rollers 14, 15 to provide tension to the film 100. The print cylinder 4 is positioned in the machine such material 7 can flow in to the cells 5 present on the surface of the print cylinder 4 from a pool of the material 7. The print cylinder 4 is then rotated along the central axis of the print cylinder 4 so that the cells 5 containing the material 7 come in to contact with the diffractive surface relief 2 of the precursor film 100. The material 7 is thus applied to the selected areas of the diffractive surface relief 2. The material 7 conforms to the surface of the diffractive surface relief 2. The material 7 also planarizes the relief so that the surface of the material 7 spaced away from the diffractive surface relief is substantially flat.

As detailed above an ink jet printer could be used instead of the print cylinder 4 to selectively apply the material 7 to the diffractive surface relief 2. When an ink jet printer is used, the area in which the material 7 is applied could be altered during the production of that batch of film. For example, if the film was later intended to be cut up in to individual holograms each hologram could contain a unique serial number or other identifying mark. Therefore the selected area would be slightly different for each hologram produced. This would be advantageous in enhancing the security of the hologram or providing a customised label for each item.

The material 7 that is applied to the diffractive surface relief 2 is formulated to have a specific refractive index. The refractive index of the material 7 could be selected to be the same as the refractive index of the medium 3 or substrate 1 that has the diffractive surface relief 2 formed in it. Alternatively, the refractive index of the material 7 could be selected to be sufficiently close to the refractive index of the medium 3 or substrate 1 that has the diffractive surface relief 2 formed in it so that the diffraction pattern is rendered non-visible. For example, the difference between the refractive index of the material 7 compared to the refractive index of the medium 3 or substrate 1 that has the diffractive surface relief formed in could be less than 20%, preferably less than 10%, and more preferably less than 5% of the refractive index of the medium 3 or substrate 1.

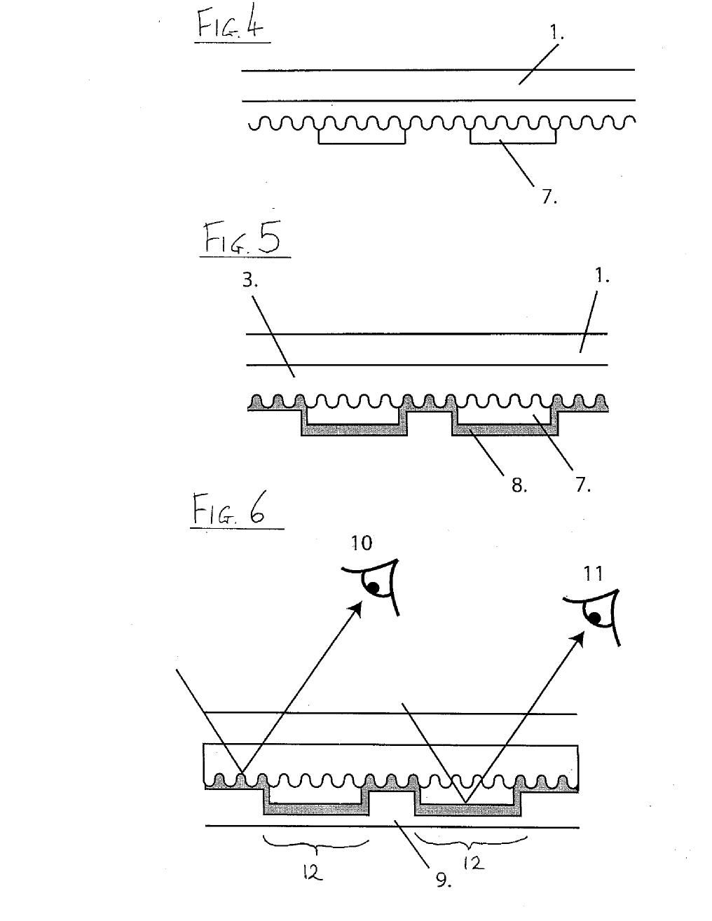

By having a similar refractive index this means that light passes from the medium 3 or substrate 1 in to the material 7 without the path of the light deviating by noticeable angle, as shown in FIG. 6 at 10 and 11. Similarly when light passes back from the material in to the medium 3 or substrate 1 it again will only deviate by a small angle, if at all. This small or non-deviation of light results in the visual effect of the diffractive surface relief 2 provided in the medium 3 or substrate 1 being nullified in the regions 12 that the material has been applied to.

Alternatively and not shown in FIG. 6, the light may pass through the medium 3 or substrate 1 and then through the material 7. In this alternative example the diffractive effect is viewed on the opposite side of the substrate 1 to the source of light.

The coat weight, or thickness of the material 7 should be sufficient to negate the effect of the diffractive surface relief 2. At low coat weights, or thicknesses, the material 7 can conform even on its outer surface to the diffractive surface relief 2. Therefore the coat weight, or thickness, of the material 7 needs to be great enough so that the material 7 planarizes the diffractive surface relief 2. The material 7 levels off the diffractive surface relief 2 which has the effect of nullifying the diffractive effect created by the diffractive surface relief 2.

Once the material 7 has been applied to the diffractive surface relief 2, there may be a period of time in which the material 7 is allowed to dry sufficiently that further layers can be applied if required. The material 7 may be a curable material, and so at this stage the material 7 may be cured, for example, using UV radiation or by heating the material 7. Alternatively the material 7, when applied, may already be formulated such that further layers can be immediately applied. For example, a coating 8 may be applied to the diffractive surface relief 2 and the material 7 that has been applied to the diffractive surface relief 2. This coating is shown to have been applied in FIG. 5.

This coating 8 could be a metallic coating, for example aluminium, which would give a metallic visual effect to the finished film. Alternatively, the coating could be a high refractive index coating, or some other required coating to give the needed visual effect to the diffractive surface pattern. For example, zinc sulphide could be used as the high refractive index coating. A protective layer 9, and/or adhesive layer 9, can applied to the coating as required by the purpose for which the film will be used. Alternatively, the protective layer 9 could also function as the coating 8.

There are various combinations of colour of material 7 and coating 8 that can be used to provide a required visual effect to that area of the film. For example, the material 7 and the medium 3 can be clear, or translucent, which when combined with a metallic or aluminium coating 8 gives a silver appearance. The material 7 can comprise a dye based translucent ink which when used with a metallic or aluminium coating 8 provides a metallic visual effect. The aforementioned effects cannot be achieved when printing translucent ink on to the surface of a finished film because the visual effect of the diffractive surface pattern beneath will show through. Alternatively the material 7 can made using an opaque ink which provides the effect of a solid colour and provides a good contrast to the areas with a diffractive pattern. By using an opaque ink in the material 7 this means that the ink cannot be scratched off as would be the case if the ink were applied after the film was complete, and/or applied to an item.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A method of producing a film having a diffractive surface pattern in selected areas by processing a precursor film having a diffractive surface relief throughout one or more zones together defining a target area of the precursor film; the method comprising:
applying material to a selected zone of the diffractive surface relief so as to nullify the diffractive effect of the surface relief in the zone.

2. A method as claimed in claim 1, wherein the material can nullify the diffractive effect of the surface relief in the zone by having a refractive index similar to that of the precursor film.

3. A method as claimed in claim 1, wherein the precursor film comprises a substrate and a layer applied to the substrate, the layer having the diffractive surface relief.

4. A method as claimed in claim 3, wherein the material can nullify the diffractive effect of the surface relief in the zone by having a refractive index similar to that of the layer having the diffractive surface relief.

5. A method as claimed in claim 1, wherein after the step of applying material the method further comprising the step of:
applying a coating to the surface of the diffractive surface relief and to the surface of the material applied to the diffractive surface relief.

6. A method as claimed in claim 5, wherein the coating is an aluminium coating.

7. A method as claimed in claims 5, wherein the coating has a high refractive index.

8. A method as claimed in claim 1, wherein the material is applied to the selected zone as a planarizing layer.

9. A method as claimed in claim 1, wherein the material is applied to the selected zone in a quantity sufficient to level off the diffractive surface relief.

10. A method as claimed in claim 1, wherein the material conforms to the diffractive surface relief.

11. A film having a diffractive surface pattern in selected areas, the film comprising:
a precursor film having a diffractive surface relief throughout one or more zones together defining a target area of the precursor film;
material applied to a selected zone of the diffractive surface relief so as to nullify the diffractive effect of the surface relief in the zone.

12. A film as claimed in claim 11, wherein the material can nullify the diffractive effect of the surface relief in the zone by having a refractive index similar to that of the precursor film.

13. A film as claimed in 11, wherein the precursor film comprises a substrate and a layer applied to the substrate, the layer having the diffractive surface relief.

14. A film as claimed in claim 13, wherein the material can nullify the diffractive effect of the surface relief in the zone by having a refractive index similar to that of the layer having the diffractive surface relief.

15. A film as claimed in claim 11, wherein the film further comprises:
a coating applied to the surface of the diffractive surface relief and to the surface of the material applied to the diffractive surface relief.

16. A film as claimed in claim 15, wherein the coating is an aluminium coating.

17. A film as claimed in claims 15, wherein the coating has a high refractive index.

18. A film as claimed in claim 11, wherein the material is a planarizing layer in the selected zone.

19. A film as claimed in claim 11, wherein the material is of sufficient thickness in the selected zone to level off the diffractive surface relief.

20. A film as claimed in claim 11, wherein the material conforms to the diffractive surface relief.
